(19) United States
(12) Patent Application Publication
(10) Pub. No.: US 2024/0168150 A1
(43) Pub. Date: May 23, 2024

(54) RADAR DEVICE FOR VEHICLE

(71) Applicant: DENSO CORPORATION, Kariya-city (JP)

(72) Inventors: Yasuhiro KURONO, Kariya-city (JP); Takuya TAKAYAMA, Kariya-city (JP)

(21) Appl. No.: 18/425,814

(22) Filed: Jan. 29, 2024

Related U.S. Application Data
(63) Continuation of application No. PCT/JP2022/028902, filed on Jul. 27, 2022.

(30) Foreign Application Priority Data
Jul. 30, 2021 (JP) 2021-125547

(51) Int. Cl. G01S 13/58; G01S 7/35; G01S 13/56; G01S 13/931; G01S 13/95

(52) U.S. Cl. CPC G01S 13/584; G01S 7/356; G01S 13/56; G01S 13/931; G01S 13/95

(57) ABSTRACT

A radar device for a vehicle includes a frequency analysis unit, a peak information acquisition unit, and a rainfall determination unit. The frequency analysis unit performs a two-dimensional fast Fourier transform on a beat signal, and the peak information acquisition unit extracts, from peaks of a power spectrum calculated by the two-dimensional fast Fourier transform, peaks within a predefined distance-velocity region preset as a raindrop condition, and acquire peak information. The rainfall determination unit determines whether a surrounding environment of the vehicle has rainfall, based on the peak information acquired by the peak information acquisition unit.

### CROSS-REFERENCE TO RELATED APPLICATION

This application is a continuation application of International Application No. PCT/JP2022/028902 filed Jul. 27, 2022 which designated the U.S. and claims priority to Japanese Patent Application No. 2021-125547 filed on Jul. 30, 2021, the contents of each of which are incorporated herein by reference.

### BACKGROUND

### Technical Field

The present disclosure relates to a radar device for a vehicle, capable of determining rainfall.

### Related Art

For an FMCW radar device that transmits a transmission signal whose frequency gradually increases and decreases in a triangular wave pattern as radar waves and detects targets by receiving the radar waves reflected from the targets, a technology is known for detecting that targets are a road surface or raindrops. FMCW is an abbreviation for Frequency Modulated Continuous Wave.

In this radar device, frequency analysis is performed on a frequency difference signal between transmission and reception signals (hereinafter referred to as a beat signal), and a peak frequency is extracted at each of a rising edge where the frequency of the transmission signal increases and a falling edge where the frequency of the transmission signal decreases. When none of the extracted peak frequency at the rising edge and the extracted peak frequency at the falling edge reach a predefined intensity, it is determined that the targets are a road surface or raindrops.

### BRIEF DESCRIPTION OF THE DRAWINGS

In the accompanying drawings:

FIG. 1 is a block diagram illustrating the configuration of a radar device according to one embodiment;

FIG. 2 is an illustration of arrangement of the radar device on a vehicle and reflection of radar waves from a road surface;

FIG. 3 is an illustration of a modulation scheme of a transmission signal transmitted from the radar device;

FIG. 4 is a functional block diagram of a processing unit;

FIG. 5 is an illustration of spectrum peaks acquired by a two-dimensional fast Fourier transform;

FIG. 6 is a flowchart of a rainfall determination process performed by the processing unit;

FIG. 7 is an illustration of a region to be excluded in peak extraction according to the road surface velocity; and

FIG. 8 is an illustration of a region to be excluded in peak extraction due to the presence of a roadside object.

### DESCRIPTION OF SPECIFIC EMBODIMENT

The above known technology, as disclosed in JP 2004-233277 A, is a technology for detecting that targets are a road surface or raindrops with the FMCW radar device, Thus, this technology can not be applied to a FCM radar device, which uses a different transmission signal modulation scheme. FCM is an abbreviation for Fast Chirp Modulation.

That is, in the FCM radar device, the frequency of the transmission signal is modulated by gradually increasing or decreasing the frequency from a start frequency to an end frequency, and such modulation is repeated in a stepwise manner. For this reason, the above technology can not be applied to determine rainfall. Thus, in order to detect rainfall in a vehicle carrying such an FCM radar device, a rainfall detector such as a raindrop sensor or the like needs to be additionally provided.

In view of the foregoing, it is desired to have a FCM radar device for a vehicle, capable of making a rainfall determination without using a rainfall detector such as a raindrop sensor.

A radar device for a vehicle, according to one aspect of the present disclosure, is configured to transmit radar waves modulated in frequency according to a FCM modulation scheme and detect targets by receiving radar waves reflected by the targets,

A radar device for a vehicle, according to the present disclosure, includes a frequency analysis unit, a peak information acquisition unit, and a rainfall determination unit.

The frequency analysis unit is configured to perform a two-dimensional fast Fourier transform on a beat signal that is a frequency difference signal between transmission and reception signals of the radar waves.

The peak information acquisition unit is configured to extract, from peaks of a power spectrum calculated by the two-dimensional fast Fourier transform in the frequency analysis unit, peaks within a predefined distance-velocity region preset as a raindrop condition, and acquire peak information that is information about the extracted peaks.

The rainfall determination unit is configured to determine whether a surrounding environment of the vehicle has rainfall, based on the peak information acquired by the peak information acquisition unit.

That is, in the FCM radar device, the frequency of the transmission signal is modulated by gradually increasing or decreasing the frequency from a start frequency to an end frequency, and such modulation is repeated in a stepwise manner.

Therefore, the FCM radar device is equipped with the frequency analysis unit that performs a two-dimensional fast Fourier transform. The two-dimensional fast Fourier transform is performed in such a manner that the distance frequency is analyzed by performing a fast Fourier transform for each chirp whose frequency gradually increases or decreases, and the velocity frequency is further analyzed by performing a fast Fourier transform on the distance frequency in the direction of successive chirps.

The frequency analysis unit yields an analysis result that peaks appear in the power spectrum in the distance-velocity coordinate system. These peaks correspond to targets such as raindrops.

Therefore, in the vehicle radar device of the present disclosure, the peak information acquisition unit extracts, from the analysis result, peaks within a predefined distance-velocity region preset as a raindrop condition, and acquire peak information that is information about the extracted peaks. The rainfall determination unit determines whether the surrounding environment has rainfall, based on the acquired peak information.

The vehicle radar device of the present disclosure allows rainfall to be detected using an FCM radar device onboard a vehicle without providing an additional rainfall detector such as a raindrop sensor. The result of rainfall detection is output to on-board devices connected to the radar device for the vehicle, for example, the driving assistance device, which enables more appropriate driving assistance to be implemented during rainfall.

Embodiments of the present disclosure will now be described with reference to the accompanying drawings.

Configuration

A radar device 10 of the present embodiment is a radar device for a vehicle, which is disposed at the front center of the vehicle 2, for example, on the back side of the front bumper, as illustrated in FIG. 2. This radar device 10 is used to detect targets ahead of the vehicle 2 by emitting radar waves in a forward direction of the vehicle 2 and receiving reflected waves from the targets.

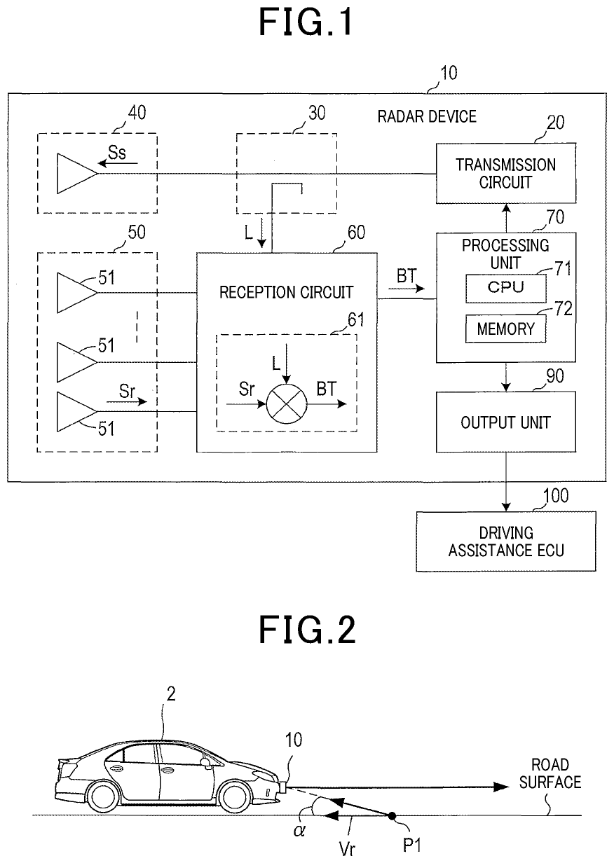

As illustrated in FIG. 1, the radar device 10 includes a transmission circuit 20, a divider 30, a transmitting antenna 40, a receiving antenna 50, a reception circuit 60, a processing unit 70, and an output unit 90.

The transmission circuit 20 is used to supply the transmission signal Ss to the transmitting antenna 40. The transmission circuit 20 inputs a high-frequency signal in the millimeter wave band to the divider 30 disposed upstream of the transmitting antenna 40.

Specifically, as illustrated in FIG. 2, the transmission circuit 20 modulates the frequency of the radio-frequency (RF) signal so that it gradually increases from the lowest start frequency to the highest end frequency, and repeats such modulation in a stepwise manner to generate an FCW-modulated RF signal, which is in turn input to the divider 30.

The divider 30 distributes power of the RF signal received from the transmission circuit into a transmission signal Ss and a local signal L.

Based on the transmission signal Ss provided from the divider 30, the transmitting antenna emits a radar wave of the frequency corresponding to the transmission signal Ss.

The receiving antenna 50 is an antenna for receiving reflected waves that are radar waves reflected from targets. The receiving antenna 50 is configured as a linear array antenna with a plurality of antenna elements 51 arranged in a row. The reception signal Sr of the reflected wave received by each antenna element 51 is input to the reception circuit 60.

The reception circuit 60 processes the reception signal Sr received from each of the antenna elements 51 that constitute the receiving antenna 50 to generate and output a beat signal BT for each antenna element 51. Specifically, using a mixer 61, the reception circuit 60 generates and outputs a beat signal BT for each antenna element 51 by mixing the reception signal Sr received from the antenna element 51 and the local signal L received from the divider 30.

Outputting the beat signal BT includes amplifying the reception signal Sr and removing unwanted signal components from the beat signal BT.

In this manner, the beat signal BT for each of the antenna elements 51, which is generated and output from the reception circuit 60, is input to the processing unit 70.

The processing unit 70 is equipped with a microcomputer including a CPU 71 and a semiconductor memory such as RAM or ROM (hereinafter a memory 72). The processing unit 70 may be equipped with a coprocessor that performs a Fast Fourier Transform (hereinafter FFT).

The processing unit 70 performs, for each target that reflected the radar wave, a target detection process to calculate a distance R to the target, a velocity V of the target, and an azimuth angle θ of the target by analyzing the beat signal BT for each antenna element 51.

The velocity V of the target is a relative velocity to the vehicle 2, and is approximately (−1)×(vehicle velocity) when the target reflecting the radar wave is a raindrop or a road surface. The azimuth angle θ of the target is calculated with the central-axis direction of the radar wave emitted from the radar device 10 as 0 degrees.

The processing unit 70 performs a rainfall determination process to determine whether it is raining, based on a result of analysis of the beat signal BT for each antenna element 51.

A result of detection of the target and a result of determination of rainfall by the processing unit 70 are output from the output unit 90 to a driving assistance ECU 100 of the vehicle 2. ECU is an abbreviation for Electronic Control Unit.

The driving assistance ECU 100 performs various operations to assist the driver in driving the vehicle 2 based on results of detection of targets received from the radar device 10. The operations related to driving assistance may include, for example, alerting the driver of the presence of an approaching object, controlling the braking and steering devices of the vehicle 2 to avoid a collision with the approaching object. The operations may include controlling drive, braking, and operating systems of the vehicle 2 to cause the vehicle 2 to follow a preceding vehicle.

Functions of Processing Unit 70

The processing unit 70 includes, as illustrated in FIG. 4, an analog-to-digital (A/D) conversion unit 82, a frequency analysis unit 84, a target detection unit 86, a peak information acquisition unit 87, and a rainfall determination unit 88, as its functional configuration.

The A/D conversion unit 82 has a function of analog-to-digital converting the beat signal BT received for each of the antenna elements 51 from the reception circuit 60 into digital data.

The frequency analysis unit 84 has a function of searching for targets in the emission direction of the radar wave by performing a fast Fourier transform (hereinafter referred to as FFT) on the digital data of the beat signals BT received from the A/D conversion unit 82.

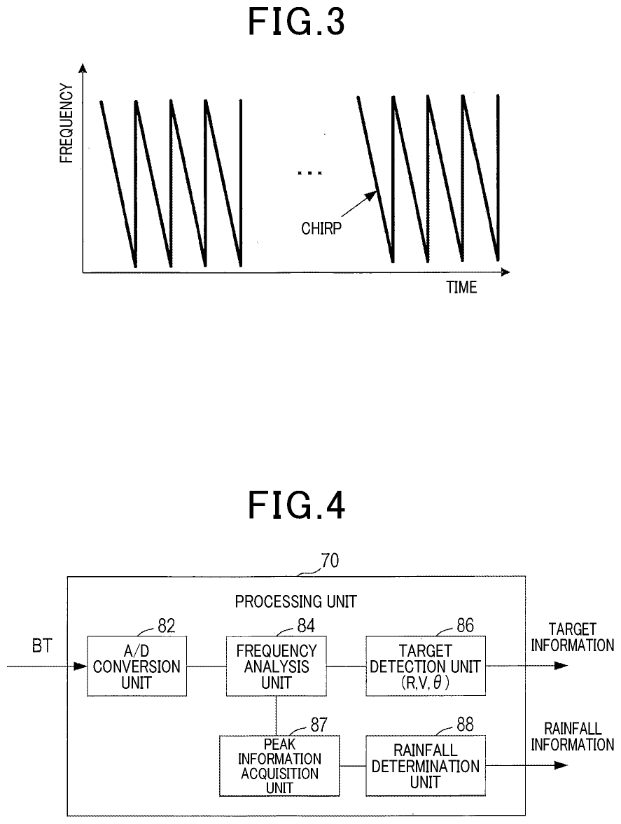

Specifically, the frequency analysis unit 84 performs a two-dimensional FFT process by analyzing the distance frequency by FFT processing the beat signal BT for each chirp of the transmission signal shown in FIG. 3, and further analyzes the velocity frequency by FFT processing the distance frequency in the chirp direction.

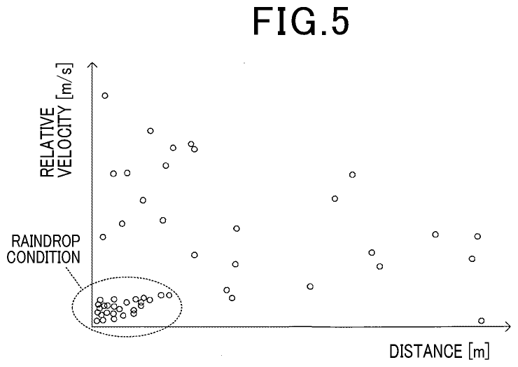

As a result, the frequency analysis unit 84 provides an analysis result in which power spectrum peaks occur in the distance-velocity coordinate system, as illustrated in FIG. 5. From the analysis result, the object detection unit 86 identifies targets in the emission direction of the radar wave and determines a distance R and a velocity V of each target. In FIG. 5, the power spectrum peaks are indicated by small circles.

The frequency analysis unit 84 performs a process of determining the azimuth angle θ of each target from the phase difference between the beat signals BT acquired from the respective antenna elements 51. The target detection unit 86 identifies and outputs to the driving assistance ECU 100 the position of each target from the distance R, velocity V, and azimuth angle θ calculated for the target.

Since the two-dimensional FFT and phase-difference-based azimuth detection scheme in FCW radar devices are well-known techniques, their details will not be described here.

The peak information acquisition unit 87 and the rainfall determination unit 88 have functions provided to the processing unit 70 to determine whether the surrounding environment has rainfall.

Of these units, the peak information acquisition unit 87 extracts, from the result of analysis acquired from the two-dimensional FFT process performed by the frequency analysis unit 84, peaks of the power spectrum within a distance-velocity region preset as a raindrop condition.

The distance-velocity region for the raindrop condition is set such that the relative velocity is approximately (−1)×(vehicle velocity) at short distances, as indicated by the dotted line in FIG. 5. The reason why the distance range for the raindrop condition is set to a short distance range is that a raindrop has a low reflection level and can only be detected at short distances.

The peak information acquisition unit 87 acquires, as peak information, the number, power, velocities, and heights of the peaks of the power spectrum extracted according to the raindrop condition. These pieces of peak information correspond to the number of raindrops, power of reflected waves from the raindrops, relative velocities of the raindrops to the vehicle 2, and heights of the raindrops from the road surface.

The rainfall determination unit 88 updates rainfall determination parameters based on the peak information acquired by the peak information acquisition unit 87, and determines whether the surrounding environment has rainfall based on the updated rainfall determination parameters.

When determining that the surrounding environment has rainfall, the rainfall determination unit 88 outputs a command to the driving assistance ECU 100 to reduce a control range of the driving assistance ECU 100, since the radar waves are attenuated by rainfall and a searchable region for targets becomes narrower.

As a result, for example, the driving assistance ECU 100 narrows a search region for a preceding vehicle to control the vehicle 2 to follow the preceding vehicle, which can prevent the preceding vehicle from being detected incorrectly due to rainfall, and thus making the vehicle-following control unstable.

Rainfall Determination Process

Next, the rainfall determination process will now be described, which is performed by the CPU 71 of the processing unit 70 to implement the functions as the peak information acquisition unit 87 and the rainfall determination unit 88.

This rainfall determination process is performed by the CPU 71 executing a program stored in memory 72.

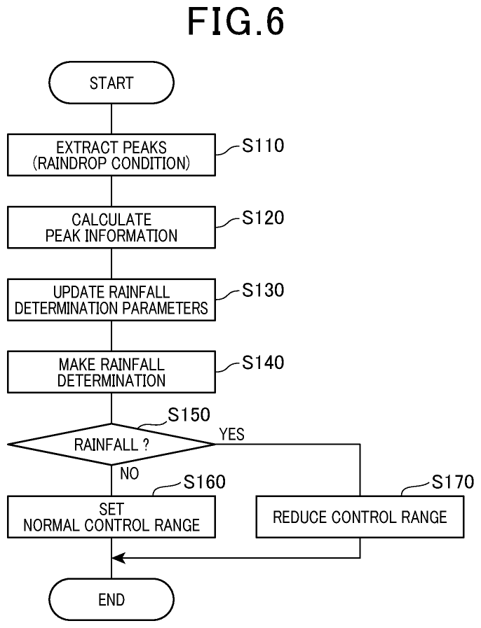

As illustrated in FIG. 6, upon initiation of the rainfall determination process, at step S110, the CPU 71 extracts peaks within the distance-velocity region that meets the raindrop condition from the power spectrum in the distance-velocity coordinate system, which is a result of analysis in the two-dimensional FFT process described above.

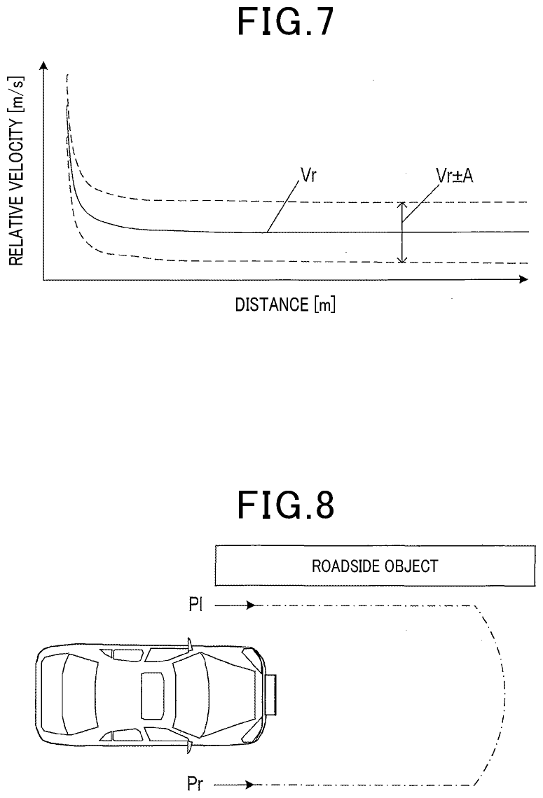

The peaks extracted at step S110 are those whose power is at or above a preset threshold value. As illustrated in FIG. 7, the raindrop condition is set so as to exclude peaks whose relative velocities are substantially equal to the relative velocity of the road surface, from peaks within the distance-velocity region described above.

In other words, when radar waves are reflected from the road surface, the relative velocities of the reflection points on the road surface are approximately (−1)×(vehicle velocity) as with raindrops, and the distances to the reflection points on the road surface overlaps a range of distances to the raindrops.

Therefore, in order to extract peaks of the power spectrum acquired by the two-dimensional FFT process that correspond to raindrops, it is desirable to exclude peaks of the power spectrum that correspond to reflected waves from the road surface.

On the other hand, the road surface velocity Vr, which is the relative velocity between the vehicle 2 and the road surface, is Vr=(−1)×(vehicle velocity)×cos(α), where a is a road surface angle as viewed from the radar device 10 to a reflection point Pl on the road surface, as illustrated in FIG. 2. The road surface angle α can be calculated as α=arcsin ((height of the radar device 10 from the road surface)/(distance to the road surface as measured from the radar device 10)).

As illustrated in FIG. 7, the road surface velocity Vr varies with distance, and a velocity range in which the peaks of the power spectrum are excluded may be set to be Vr±A [m/s]. Therefore, in the present embodiment, the raindrop condition is set such that the peaks of the power spectrum are not extracted in this velocity range.

As illustrated in FIG. 8, in the presence of a roadside object on either side of vehicle 2, it is conceivable that reflected waves from the roadside object may be extracted as raindrops. In the present embodiment, as illustrated in FIG. 8, the raindrop condition is set such that the peaks of the power spectrum located within a region outside the left and right boundary lines Pl and Pr, in which there assumed to be a roadside object in a lateral direction of the vehicle, are not extracted. The left and right boundary lines Pl and Pr are set such that there may be roadside objects outside these lines in the width direction of vehicle 2.

This can prevent radar wave reflection points on the road surface and roadside objects from being extracted as raindrops.

Next, at step S110, upon extracting the peaks of the power spectrum that meet the raindrop condition described above, the CPU 71 proceeds to step S120 to calculate information about the extracted peaks. At step S120, as described above, the CPU 71 calculates the number, power, velocities, and heights of the peaks of the power spectrum extracted at step S110, as peak information. However, it is not necessary to calculate all of these parameters. For example, one or some of these parameters may be calculated.

Upon calculating the peak information at step S120, the CPU 71 proceeds to step S130 to update the rainfall determination parameters based on the calculated peak information.

In the present embodiment, the rainfall determination parameters include the rainfall counter, rainfall power, raindrop velocity variability, and raindrop height variability.

The rainfall counter is a counter of the number of raindrops. For example, the rainfall counter is updated based on the following equation, where the current number of raindrops is the number of peaks calculated at step S120.

Rainfall Counter=Previous Rainfall Counter+(Current Number of Raindrops−2)

The rainfall power is a moving average of raindrop power. For example, the rainfall power is updated based on the following equation, where current maximum raindrop power is power of the peak with the maximum power among the peaks extracted at present.

Rainfall Power=(0.995×Previous Rainfall Power)+(0.005×Current Maximum Raindrop Power)

Instead of the current maximum raindrop power, the rainfall power may be updated using, for example, the average of power of the peaks extracted at present.

The velocity variability of raindrops is calculated as follows. For example, the velocity average for all raindrops corresponding to the peaks extracted at present is calculated using the following equation.

Velocity Average=(0.95×Previous Velocity Average)+(0.05×Current Raindrop Velocity)

Based on that velocity average, the velocity variability of raindrops is calculated according to the following equation by calculating the so-called standard deviation.

Velocity Variability=(0.95×Previous Velocity Variability)+(0.95×0.05×(Current Raindrop Velocity−Velocity Average)\hat{ }2)

The height variability of raindrops is calculated as follows. For example, the height average for all raindrops corresponding to the peaks extracted at present is calculated using the following equation.

Height Average=(0.95×Previous Height Average)+(0.05×Current Raindrop Height)

Based on the height average, the height variability of raindrops is calculated according to the following equation by calculating the so-called standard deviation.

Height Variability=(0.95×Previous Height Variability)+(0.95×0.05×(Current Raindrop Height−Height Average)\hat{ }2)

The values in the above equations are examples and may be changed as needed. The notation “\hat{ }2” represents the square operation.

Next, at step S140, the CPU 71 makes a rainfall determination using the rainfall determination parameters calculated at step S130.

That is, when the rainfall counter is high, it may be determined that there is rainfall because there are many raindrops. When the rainfall power is high, it may be determined that radio wave attenuation due to raindrops is high. When the velocity variability or the height variability of raindrops is low, peaks different from raindrops, such as a road surface, are likely to have been extracted.

Therefore, at step S140, when the rainfall counter, rainfall power, velocity variability, and height variability are each higher than a respective predefined threshold value, it is determined that there is rainfall.

In the present embodiment, when the rainfall counter, rainfall power, velocity variability, and height variability are all high, it may be determined that there is rainfall. Alternatively, when the rainfall counter and rainfall power are both high, it may be determined that there is rainfall. That is, it may be determined that there is rainfall when one or some of the rainfall determination parameters are high.

Although the rainfall counter, rainfall power, velocity variability, and height variability are calculated as rainfall determination parameters, one or some of these parameters may be calculated as rainfall determination parameters to make a rainfall determination.

Next, at step S150, the CPU 71 determines whether it has been determined that there is rainfall at step S140. If the answer is NO, the CPU 71 proceeds to step S160, and if the answer is YES, the CPU 71 proceeds to step S170.

At step S160, since it is not determined that there is rainfall and the driving assistance ECU 100 may perform control without being affected by rainfall, the CPU 71 outputs a command to the driving assistance ECU 100 to set the control range to a normal control range with a result of rainfall determination. Thereafter, the rainfall determination process ends.

On the other hand, at step S170, since it is determined that there is rainfall and control by the driving assistance ECU 100 is affected by rainfall, the CPU 71 outputs a command to the driving assistance ECU 100 to reduce the control range with a result of rainfall determination. Thereafter, the rainfall determination process ends.

After completing the rainfall determination process, the CPU 71 repeats the above process for a predefined time period by returning to step S110.

In the flowchart illustrated in FIG. 6, steps S110 and S120 correspond to the function of the peak information acquisition unit 87 illustrated in FIG. 4, and steps S130 to S170 correspond to the function of the rainfall determination unit 88 illustrated in FIG. 4.

Advantages

As described above, in the present embodiment, a rainfall determination is made in the FCM radar device 10 using the two-dimensional FFT process that is performed by the frequency analysis unit 84. In this rainfall determination, from the power spectrum in the distance-velocity coordinate system acquired in the two-dimensional FFT process, peaks in a region where raindrops are detected by the radar device 10 are extracted as raindrops, and the rainfall determination is made based on information about these peaks (referred to as peak information).

The number of peaks and power of the peaks are acquired as peak information to be used in the rainfall determination, and these parameters are used in the rainfall determination as the number of raindrops and power of the raindrops, which allows the rainfall determination to be made very accurately.

In the present embodiment, a region of the power spectrum in the distance-velocity coordinate system, from which peaks are extracted, is limited so that reflected waves from the road surface or roadside objects are not recognized as raindrops. This allows the rainfall determination to be made more accurately.

Even if reflected waves from the road surface or roadside objects are recognized as raindrops, the velocity variability of raindrops and the height variability of raindrops are used to make a rainfall determination. This can prevent the accuracy of rainfall determination from deteriorating.

### Other Embodiments

While the specific embodiment of the present disclosure has been described above, the present disclosure is not limited to the above-described embodiment, and may be implemented with various modifications.

The control unit 70 and its rainfall determination method described in the present disclosure may be implemented by a dedicated computer including a processor and a memory programmed to execute one or more functions embodied by computer programs. Alternatively, the control unit 70 and its rainfall determination method described in the present disclosure may be implemented by a dedicated computer including a processor formed of one or more dedicated hardware logic circuits, or may be implemented by one or more dedicated computers including a combination of a processor and a memory programmed to execute one or more functions and a processor formed of one or more dedicated hardware logic circuits. The computer programs may be stored, as instructions to be executed by a computer, in a non-transitory, tangible computer-readable storage medium. The technique for implementing the functions of each part included in the control unit 70 does not necessarily include software, and all of its functions may be implemented using one or more pieces of hardware.

A plurality of functions possessed by one constituent element in any one of the foregoing embodiments may be implemented by a plurality of constituent elements, or one function possessed by one constituent element may be implemented by a plurality of constituent elements. In addition, a plurality of functions possessed by a plurality of constituent elements may be implemented by one constituent element, or one function implemented by a plurality of constituent elements may be implemented by one constituent element. Some of the components in any one of the foregoing embodiments may be omitted. At least part of configuration of any one of the foregoing embodiments may be added to or replaced with configuration of another one of the foregoing embodiments.

Besides the radar device for a vehicle described above, the present disclosure can be implemented in various modes such as a system including the radar device for a vehicle as a constituent element, a program for causing a computer to serve as the radar device for a vehicle, a non-transitory and tangible storage medium such as a semiconductor memory storing this program, the rainfall determination method of the radar device for a vehicle, and others.

What is claimed is:

1. A radar device for a vehicle, configured to transmit radar waves modulated in frequency according to a FCM modulation scheme and detect a target by receiving radar waves reflected by the target, comprising:
a frequency analysis unit configured to perform a two-dimensional fast Fourier transform on a beat signal that is a frequency difference signal between transmission and reception signals of the radar waves;
a peak information acquisition unit configured to extract, from peaks of a power spectrum calculated by the two-dimensional fast Fourier transform in the frequency analysis unit, peaks within a predefined distance-velocity region preset as a raindrop condition, and acquire peak information that is information about the extracted peaks; and
a rainfall determination unit configured to determine whether a surrounding environment of the vehicle has rainfall, based on the peak information acquired by the peak information acquisition unit.

2. The radar device according to claim 1, wherein
the peak information acquisition unit is configured to acquire, as the peak information, a number of the extracted peaks, and
the rainfall determination unit is configured to, when the number of the extracted peaks is large, determine that there is rainfall.

3. The radar device according to claim 1, wherein
the peak information acquisition unit is configured to acquire, as the peak information, power of the extracted peaks, and
the rainfall determination unit is configured to, when the power of the extracted peaks is high, determine that there is rainfall.

4. The radar device according to claim 1, wherein
the peak information acquisition unit is configured to acquire, as the peak information, velocity variability of the extracted peaks, and
the rainfall determination unit is configured to, when the velocity variability of the extracted peaks is high, determine that there is rainfall.

5. The radar device according to claim 1, wherein
the peak information acquisition unit is configured to acquire, as the peak information, height variability of the extracted peaks, and
the rainfall determination unit is configured to, when the height variability of the extracted peaks is high, determine that there is rainfall.

6. The radar device according to claim 1, wherein
the peak information acquisition unit is configured to, when extracting peaks within the predefined distance-velocity region, exclude peaks whose relative velocities are substantially equal to a relative velocity of a road surface.

7. The radar device according to claim 1, wherein
the peak information acquisition unit is configured to, when extracting peaks within the predefined distance-velocity region, exclude peaks within a region in which there assumed to be a roadside object in a lateral direction of the vehicle.

8. A radar device for a vehicle, configured to transmit radar waves modulated in frequency according to a FCM modulation scheme and detect a target by receiving radar waves reflected by the target, comprising:
a non-transitory memory storing one or more computer programs; and
a processor executing the one or more computer programs to:
perform a two-dimensional fast Fourier transform on a beat signal that is a frequency difference signal between transmission and reception signals of the radar waves;
extract, from peaks of a power spectrum calculated by the two-dimensional fast Fourier transform, peaks within a predefined distance-velocity region preset as a raindrop condition, and acquire peak information that is information about the extracted peaks; and
determine whether a surrounding environment of the vehicle has rainfall, based on the acquired peak information.
